(19) United States
(12) Patent Application Publication
(10) Pub. No.: US 2023/0273972 A1
(43) Pub. Date: Aug. 31, 2023

(54) PROCESSOR INSTRUCTION SET ARCHITECTURE FOR MACHINE LEARNING WITH LOW BIT PRECISION WEIGHTS

(71) Applicant: TEXAS INSTRUMENTS INCORPORATED, Dallas, TX (US)

(72) Inventors: Mahesh Madhukar MEHENDALE, Dallas, TX (US); Uri WEINRIB, Mazkeret Batya (IL); Avi Sammy BERKOVICH, Herzerlia (IL)

(21) Appl. No.: 17/682,520

(22) Filed: Feb. 28, 2022

(51) Int. Cl. G06F 17/16; G06F 5/01; G06N 3/04

(52) U.S. Cl. CPC G06F 17/16; G06F 5/01; G06N 3/04

(57) ABSTRACT

A technique for controlling a processing device. The technique includes receiving, from a first register, input feature values. The technique also includes receiving, from a second register, weight values. The technique further includes receiving first addresses of output registers. The technique also includes performing a matrix multiplication of the input feature values and weight values in parallel to obtain matrix multiplication results. The technique further includes providing the matrix multiplication results to the output registers.

### BACKGROUND

Machine learning (ML) is becoming an increasingly important part of the computing landscape. Machine learning may be implemented via ML models. Machine learning is a branch of artificial intelligence (AI), and ML models helps enable a software system to learn to recognize patterns from data without being directly programmed to do so. Neural networks (NN) are a type of ML mod& which use a set of linked and layered functions (e.g., nodes, neurons, etc.) which are weighted to evaluate input data. In some NNs, sometimes referred to as convolution NNs (CNNs), convolution operations are performed in NN layers based on inputs received and weights. Machine learning models are often used in a wide array of applications often for recognition and classification, such as image recognition and object classification, prediction and recommendation systems, speech and language recognition and translation, sensing, etc.

As ML becomes increasingly useful, there is a desire to execute complex ML techniques, such as NNs and CNNs, efficiently in devices with relatively limited compute resources, such as embedded, or other low-power devices. Techniques for optimizing performance of ML models on lower cost and/or power processors may be useful.

### SUMMARY

This description relates to a technique for controlling a processing device. The technique includes receiving, from a first register, input feature values. The technique also includes receiving, from a second register, weight values. The technique further includes receiving an indication of output registers. The technique also includes performing a matrix multiplication of the input feature values and weight values in parallel to obtain matrix multiplication results. The technique further includes providing the matrix multiplication results to the output registers based on the received indication of the output registers.

Another aspect of this description relates to a system. The system includes a first register configured to receive input feature values. The system further includes a second register configured to receive weights. The system also includes output registers. The system further includes a processor. The processor includes a set of multipliers. The processor also includes a series of adders. The processor is configured to receive the input feature values from the first register. The processor is also configured to receive the weights from the second register. The processor is configured to receive an indication of the output registers. The processor is also configured to process, by the set of multipliers, the input feature values and the weights to obtain intermediate results. The processor is configured to process, by the series of adders, the intermediate results to obtain a matrix multiplication output value. The processor is also configured to provide the matrix multiplication output value to the output registers based on the received indication.

Another aspect of this description relates to an electronic circuit. The electronic circuit includes a first register configured to store input feature values. The electronic circuit also includes a second register configured to store weight values. The electronic circuit further includes output registers configured to provide a matrix multiplication output value. The electronic circuit also includes a processor coupled to the first register, the second register, and the output registers. The processor includes a set of multipliers configured to process the input feature values and the weights to obtain intermediate results, and a series of adders configured to process the intermediate results to obtain the output value.

### BRIEF DESCRIPTION OF THE DRAWINGS

FIG. 1 illustrates an example NN ML model, in accordance with aspects of this description.

FIG. 2 is a block diagram of an example convolution function, in accordance with aspects of this description.

FIG. 3 is a conceptual diagram of a convolution operation as matrix multiplication, in accordance with aspects of this description.

FIG. 4 is a conceptual diagram of an example matrix multiplication instruction for performing a matrix multiplication operation on a general purpose CPU, in accordance with aspects of this description.

FIG. 5 is a block diagram of a logical implementation for the example matrix multiplication instruction, in accordance with aspects of this description.

FIG. 6 is a conceptual diagram of an example matrix multiplication post processing instruction for performing a matrix multiplication operation on a general purpose CPU, in accordance with aspects of this description.

FIG. 7 is a block diagram of a logical implementation for the example matrix multiplication post processing instruction, in accordance with aspects of this description.

FIG. 8 illustrates example pseudocode for using the added instructions for convolution, in accordance with aspects of this description.

FIG. 9 is a conceptual diagram of an example matrix multiplication post processing instruction for performing a matrix multiplication operation on a general purpose CPU, in accordance with aspects of this description.

FIG. 10 is a block diagram of a logical implementation of a matrix multiplication post processing instruction, in accordance with aspects of this description.

FIG. 11 is a conceptual diagram of an example matrix multiplication post processing instruction for performing a matrix multiplication operation on a general purpose CPU, in accordance with aspects of this description.

FIG. 12 is a block diagram of a logical implementation for the example matrix multiplication post processing instruction, in accordance with aspects of this description.

FIG. 13 is a conceptual diagram of an example matrix multiplication post processing instruction for performing a matrix multiplication operation on a general purpose CPU, in accordance with aspects of this description.

FIG. 14 is a block diagram of a logical implementation for the example matrix multiplication post processing instruction, in accordance with aspects of this description.

FIG. 15 is a conceptual diagram of an example matrix multiplication post processing instruction for performing a matrix multiplication operation on a general purpose CPU, in accordance with aspects of this description.

FIG. 16 is a block diagram of a logical implementation for the example matrix multiplication post processing instruction, in accordance with aspects of this description.

FIG. 17 is flow diagram of a technique for matrix multiplication by a processor, in accordance with aspects of this description.

FIG. 18 is a block diagram of a device in accordance with aspects of this description.

### DETAILED DESCRIPTION

As ML has becoming more common and powerful, it may be useful to execute ML models on lower cost hardware, such as low-powered devices, embedded device, commodity devices, etc. As used herein, an ML model may refer to an implementation of one or more ML algorithms which model an action, such as object recognition, behavior of a circuit, data analysis, etc. In cases where a target hardware for executing ML models is expected to be a lower cost and/or power processor, the ML models may be optimized for the target hardware configurations to help enhance performance. To help an ML model execute on lower cost and/or power processors, ML models may be implemented with relatively low precision weights. Also, such processors may include one or more instructions of an instruction set architecture (ISA) optimized for executing ML models with relatively low precision weights.

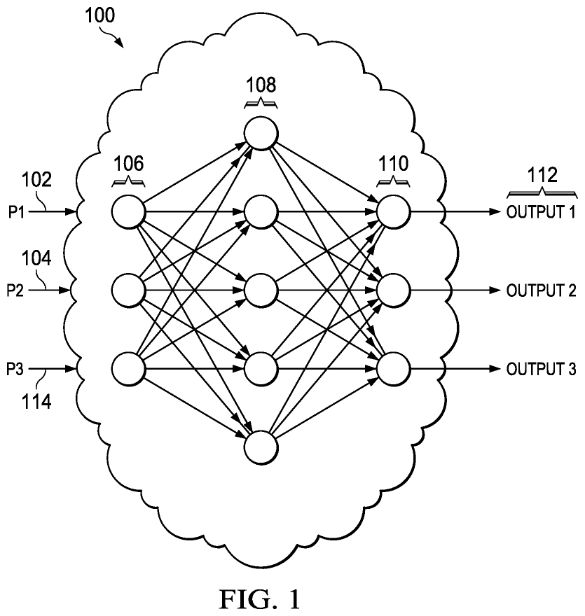

FIG. 1 illustrates an example NN ML model 100, in accordance with aspects of this description. Notably, the same reference number is used in the drawings for the same or similar (either by function and/or structure) features. The example NN ML model 100 is a simplified example presented to describe how an NN ML model 100, such as a CNN, is structured and trained. Examples of NN ML models may include HelloEdge, LeNet, Alex Net, Mobilnet, etc. Each implementation of an ML model may execute one or more ML algorithms and the ML model may be trained or tuned in a different way, depending on a variety of factors, including, but not limited to, a type of ML model being used, parameters being used for the ML model, relationships as among the parameters, desired speed of training, etc. In this simplified example, feature values of P1, P2, and P3 are feature inputs 102, 104, and 114, which are provided into the ML model 100. Generally, parameters may refer to aspects of mathematical functions that may be applied by nodes of the NN ML model 100 to features, which are the data points or variables.

Each layer (e.g., first layer 106, second layer 108, and third layer 110) includes nodes (e.g., neurons) and generally represents a set of operations performed on the features, such as a set of matrix multiplications, convolutions, deconvolutions, etc. For example, each node may represent a mathematical function that takes, as input features (aside from the nodes of the first layer 106), output features from a previous layer and a weight. The ML model outputs 112 are provided by the last layer (e.g., the third layer 110). The weight is usually adjusted during ML model training and fixed after the ML model training. In a ML model with relatively low precision weights, the weights may be limited to a set of fixed values. In some cases, the set of fixed values may be limited to those that can be represented with one or two bits such as [1, 0, and −1] or [1, −1] (e.g., binary or ternary values).

While the current example addresses three layers, in some cases the ML model may include any number of layers. Generally, each layer transforms M number of input features to N number of output features. The features provided to the first layer 106 are output as input features to the second layer 108 via a set of connections. In this example, as each node of a layer (such as first layer 106) outputs to each node in a subsequent layer (such as second layer 108), ML model 100 is a fully connected NN. Other embodiments may use a partially connected NN or another NN design which may not connect each node of a layer to each node of a subsequent layer, where some node connections may skip layers, where no feedback is provided from output to inputs (e.g., Feed Forward CNN), etc.

In this example, first layer 106 represents a mathematical function based on a set of weights that are applied to the input features (e.g., input features 102, 104, and 114) to generate output from first layer 106 that is provided to the second layer 108. Different weights may be applied for the input received from each node of the previous layer by the subsequent layer. For example, for a node of the second layer 108, the node applies weights to input received from nodes of the first layer 106 and the node may apply a different weight to input received from each node of the first layer 106. Nodes compute one or more mathematical functions based on the inputs received and corresponding weights and outputs a number. This output number may be provided to subsequent layers, or if the layer is a final layer, such as third layer 110 in this example, the number may be output as a result (e.g., output features or ML model outputs 112).

The specific mathematical function applied at a layer and/or node can vary depending on ML model implementation. For an ML model with relatively low precision weights, by limiting the values of the weights to one or two bits, the mathematical functions can be limited to addition/subtraction operations, which simplifies the processing of the mathematical functions.

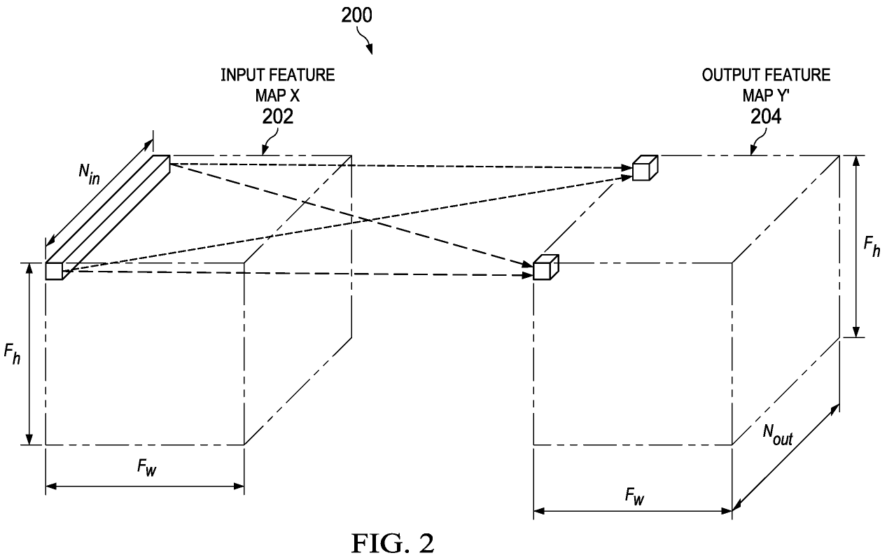

FIG. 2 is a block diagram 200 of an example convolution function, in accordance with aspects of this description. In certain ML models, one or more nodes of a layer may apply a convolution operation to a set of input features to generate a set of output features. Features in the sets of input features and output features may be grouped in a data structure such as an input feature map X 202 and an output feature map Y′ 204 where each feature may be identified based on a coordinated system (e.g., height, width, depth) of the data structure. Weights to be applied to the features may also be included in the data structure, for example, as another dimension of the data structure. In this example, three dimensions are shown for clarity and a dimension illustrated in this example may represent multiple dimensions. For example, input features may occupy two-dimensions of the input feature map X 202, where the input features have a width of F_{w}, and a height of Fₕ and multiple such input features are stacked along the third dimension, representing Nᵢₙ input channels.

Similarly, the output feature map 204 may have a width of F_{w}, and a height of Fₕ and multiple output features stacked along the third dimension representing Nₒᵤₜ output channels.

Programmatically, a basic convolution operation may be represented as a set of nested loops along with a post processing step. A convolution operation, at its core, can be broken down to a multiply and accumulate operation for the features against the weights. The below pseudo-code illustrates a code flow for an example pointwise (e.g., 1×1 convolution) operation. Notably, while a pointwise operation is illustrated in this example below, the concepts embodied herein may be generalized to generic convolution operations and other types of layers, such as fully connected layers.

| | |
|---|---|
| 1. | for (i = 0 to (Fₕ−1)) |

{

| | |
|---|---|
| 2. | for (j = 0 to (F_{w}−1)) |
| | { |
| 3. | for (n = 0 to (Nₒᵤₜ−1)) |
| | { |
| 4. | for (m = 0 to (Nᵢₙ−1)) |
| | { |
| 5. | Y'[i][j][n] += X[i][j][m] * W[n][m]; |
| | } |
| 6. | Y'[i][j][n] = (Y'[i][j][n] + Bias[n]) * Scale[n]; |
| | } |
| 7. | Y[i][j][n] = Clamp (Y'[i][j][n] >> shift[n], Low, High); |
| | } |

}

In this example, X[i][j][n] may be an 8-bit signed or unsigned feature, weight W[n][m] may be 2-bit, the bias Bias[n] may be 16-bit unsigned, Scale[n] may be 5-bit unsigned, and the clamp value may be 8-bit. In the example pseudo-code, lines 1-4 are a set of nested loops to iterate through the features for the convolution operation at line 5. At line 5, a particular feature is multiplied against a weight. In a ML model with relatively low precision weights, the weights may be limited to a set of fixed values such as [1, 0, and −1]. The relatively low precision weight helps allow the convolution operation to be performed as a null, zeroing, or negation operation instead of a multiplication and accumulate operation. Lines 6 and 7 are post-processing steps for normalizing bit precision of the output of the convolution operation in line 5. Here, line 6 applies a bias and scales the output feature value and line 7 performs a bit right shift for the accumulate step and clamps the results to ensures that the output feature values remain within a certain maximum and minimum values.

In accordance with aspects of this description, part of the convolution operation may be performed as a series of matrix multiplications. In some cases, the convolution operation may be performed as a series of 4×4 matrix multiplication. For example, matrices for convolution operations that are being matrix multiplied can have many more dimensions (and hence input values) than will fit into registers of a processor. These matrices may be partitioned into a series of smaller 4×4 matrix multiplications and an instruction may be defined to perform the 4×4 matrix multiplication in a single processor cycle. Notably, the exact size of the matrices of the series of matrix multiplications may be based on a size of registers of the processor. In the case of a processor with 32-bit registers, 4×4 matrices may be used. As another example, a processor with a 64-bit registers a series of 8×4 matrix multiplications may be used. Also, smaller dimensioned matrices may also be used in some cases.

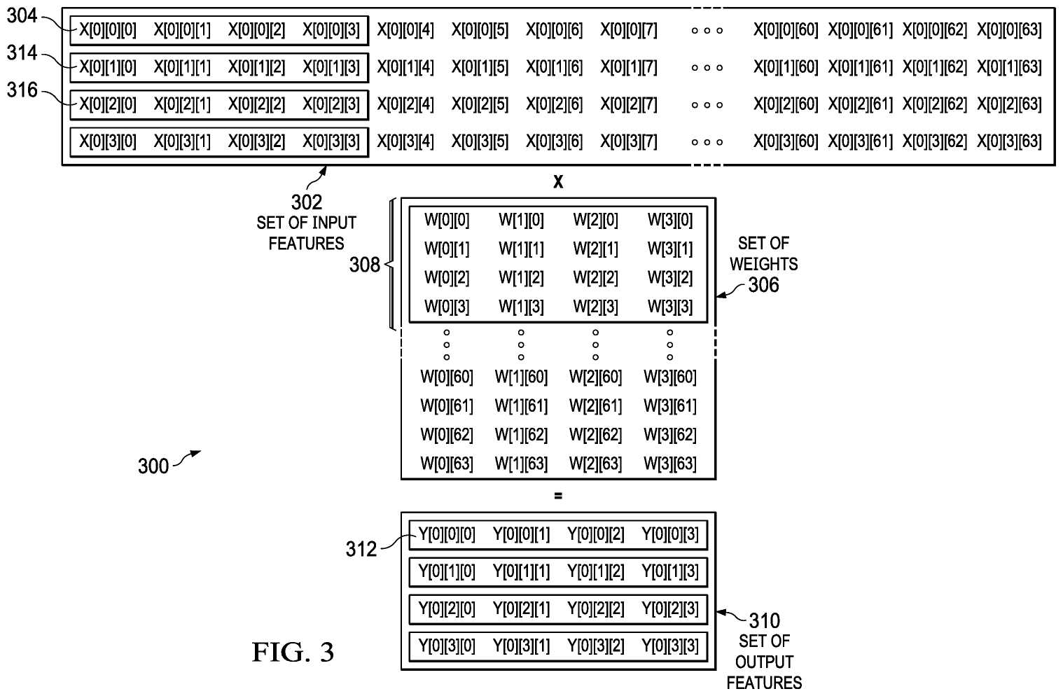

FIG. 3 is a conceptual diagram 300 of a convolution operation as matrix multiplication, in accordance with aspects of this description. Continuing with the example above, with 32-bit registers—four 8-bit input features X[i][j][n] may fit in a register. Thus, four input features, of the overall set of input features 302, may be selected for an input features matrix 304. The weights W[n][m] may be 2-bit and thus 16 weights may fit in another 32-bit register. Sixteen weights, of the overall set of weights 306, may be selected for a weight matrix 308. The input features matrix 304 may be multiplied against the weight matrix 308 to generate an output features 312 matrix of a portion of a set of output features 310. In this example, the output features, Y′[i][j][n] may be 16-bit, to accommodate results of both the multiply and accumulate operations, and four outputs may fit in two registers. The process may be repeated for a second input features matrix 314, a third input features matrix 316 and so forth until the input features of the set of input features 302 have been so processed.

In some cases, a general purpose CPU, as opposed to a matrix processor, AI accelerator, or dedicate co-processor, may not have an atomic instruction for performing a matrix multiplication operation such as the one described above for part of the convolution operation. For example, the instruction set for ARM Cortex (ARM and Cortex are registered trademark owned by ARM Limited Corporation) processors do not include an instruction that performs an atomic matrix multiplication operation. Rather, a general purpose CPU may perform the multiple and accumulate operation as a series of operations for each input feature and weight, which can be relatively inefficient. Instead, an atomic matrix multiplication instruction may be provided to allow multiple input features to be multiplied against multiple weights to perform the multiply and accumulate operations for the convolution operation.

Adding a matrix multiplication operation at an ISA level helps tightly integrate ML model processing with a processor and allows access to the memories and registers that the processor already has access to. This close integration may help provide for lower latency operations as added ML instructions may be interleaved with existing instructions. Also, by allowing the processor to efficiently handle ML processing tasks helps avoid additional costs and complexity that may be incurred by including a co-processor, dedicated ML processor, etc.

In some cases, the ML instructions may be added, for example, to an existing instruction set for a processor. Also, certain processors may support custom datapath extensions. Custom datapath extensions may allow customized instructions to be defined, along with specific operations to be performed when these customized instructions are called. For example, a processor vendor may be able to use custom datapath extensions to define additional instructions to the ISA of a processor as well as logical operations to perform in response to the added instructions. In some cases, the ML instructions may be added using such custom datapath extensions. The custom datapath extensions may have certain limitations, such as limits on a number of operands (e.g., inputs and outputs) the custom instructions may be able to accept, operate just on registers, limit the operations of the custom instructions to be performed using only combinational logic with no capability to define additional storage elements such as registers, flops, latches etc.

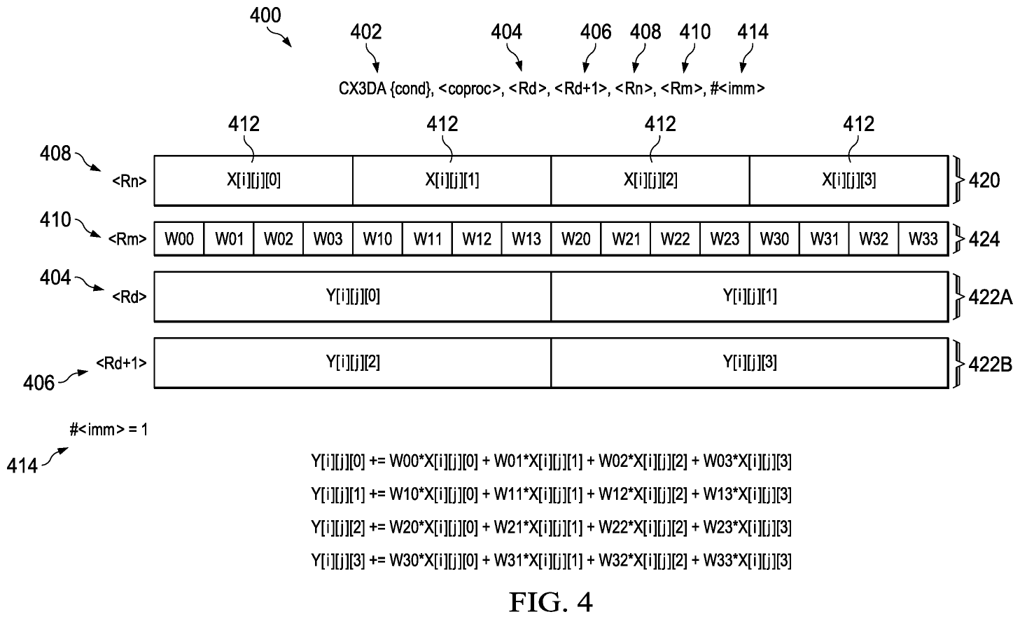

FIG. 4 is a conceptual diagram 400 of an example matrix multiplication instruction for performing a matrix multiplication operation on a general purpose CPU, in accordance with aspects of this description. In diagram 400, a matrix multiplication instruction CX3DA 402 is shown. Notably, the example instructions, such as CX3DA 402, CX2A, C2XDA, etc., provided in this description are described formatted as ARM Cortex-M custom datapath extensions. The concepts embodied herein are not limited to ARM processors or processors with a custom datapath extensions, but may be implemented as a part of an instruction set for other processors. The instruction CX3DA 402 accepts four parameters, <Rd> 404, <Rd+1> 406, <Rn> 408, and <Rm> 410 for the convolution operation. In this example, the <Rn> 408 parameter may indicate a register 420 into which four input features 412 have been written. In some cases, this indication may be a register address. The parameters <Rd> 404 and <Rd+1> 406 may indicate registers 422A and 422B which output features may be written to, and the parameter <Rm> 410 may indicate a register 424 into which 16 weights have been written to. The four input features 412 may then be multiplied against the 16 weights in a matrix multiplication operation to provide four output features 414 by performing 16 multiply and accumulate operations in parallel per processor cycle for the convolution operation. Parameter #<imm> 414 may indicate which operations should be performed. In this case, parameter #<imm> 414 is set to one, indicating that a matrix multiplication operation is to be performed, for example via the operations as shown. In some cases, additional parameters may be provided for controlling the execution of the instruction, such as {cond}, <coproc>, and #<imm>, which are ARM specific parameters.

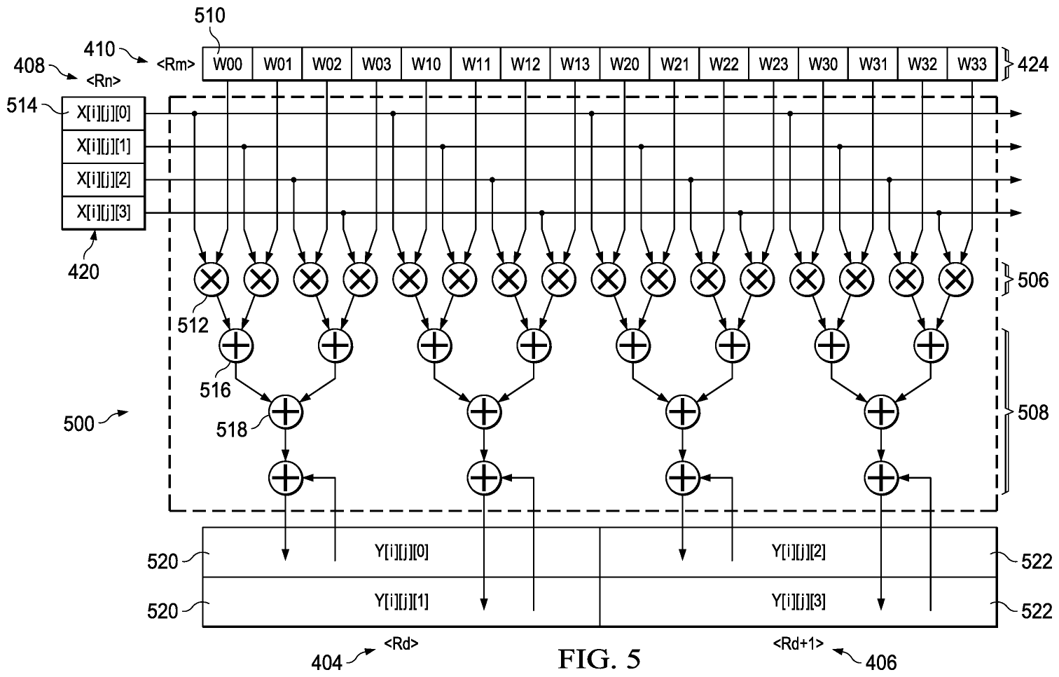

FIG. 5 is a block diagram 500 of a logical implementation for the example matrix multiplication instruction, in accordance with aspects of this description. The logical implementation shown in diagram 500 illustrates an implementation of matrix multiplication instruction CX3DA 402. As shown, a group of weights are stored in register 424 corresponding to parameter <Rm> 410 and a group of input features are stored in register 420 corresponding to parameter <Rn> 408. Register 424 and register 420 are both coupled to a set of multipliers 506 and a series of adders 508 (e.g. multiple adders arranged serially). As the weights are limited to those that can be represented with one or two bits such as [1, 0, and −1] or [1, −1], the multipliers 506 may be implemented as conditional add/zero/subtract operations to help reduce silicon area, power, and improve speed as compared to multipliers that are configured to accept any values. The multipliers, and adders may be one or more logic gates arranged to perform a multiplication operation and an addition operation, respectively. The multipliers and adders shown in the block diagram are arranged to perform the operations where the parameter #<imm> 414 has a value of 1. As shown, a number of multipliers may correspond to a number of weights that can be processed. Here, 16 low precision weights may be stored in the register and therefore the set of multipliers 506 includes 16 multipliers. Input features stored in register 420 are also provided to the appropriate multipliers and the set of multipliers 506 multiplies the weights and corresponding input features.

Referring back to parameter #<imm> 414 of FIG. 4, one operation to be performed is Y[i][j][0]+=W00*X[i][j][0]+W01*X[i][j][1]+W02*X[i][j][2]+W03*X[i][j][3]. As shown, weight WOO 510 and input feature X[i][j][0] 514 are coupled to multiplier 512. Multiplier 512 may multiply the values of weight W00 510 and input feature X[i][j][0] 514 to obtain an intermediate result. The intermediate results of the multiplication operations performed by the set of multipliers 506 are then provided through a series of adders 508 to sum the column values for the matrix multiplication. Here, the intermediate results of multiplier 512 are summed with the results of W01*X[i][j][1] by adder 516. The intermediate results of adder 516 are then summed with the results of W02*X[i][j][2]+W03*X[i][j][3] by adder 518 and accumulated to partial results in the registers 520 and 522. The results of the matrix multiplication are then provided to registers 520 and 522 which correspond to parameters <Rd> 422A and <Rd+1> 422B, respectively. In some cases, multiple input feature values and weights may be multiplied, for example, by additional sets of registers, multipliers, and adders, in parallel.

Post processing steps may be performed after the matrix multiplication where a particular group of input features have been multiplied by the corresponding weights to obtain an output result of the matrix multiplication. In some cases, the post processing steps apply a bias, scale, bit shift, and clamping. This post processing can be expressed as Yₒᵤₜ=clamp(((Yᵢₙ+Bias)*Scale)>>Shift, Low, High), where Yₒᵤₜ represents output result, Yᵢₙ represents the output of the matrix multiplication operation, clamp represents limits between which the output should remain within and may include a high and low limit, Scale represents a multiplicative factor, and >>shift may be a value which represents a number of bits over which to perform a right shift. In some cases, Yₒᵤₜ may be a 8-bit output, Yᵢₙ may be a 16 bit signed value (e.g., a result of an input feature multiplied by a weight), scale may be an 8-bit multiplicative value, and bias may be a 16 bit signed value. In some cases, the shift may be represented by a 5-bit value and the clamp value may be a 3-bit value with the values mapping to certain predetermined ranges, such as 0-255, 0-127 , −128-127, etc.

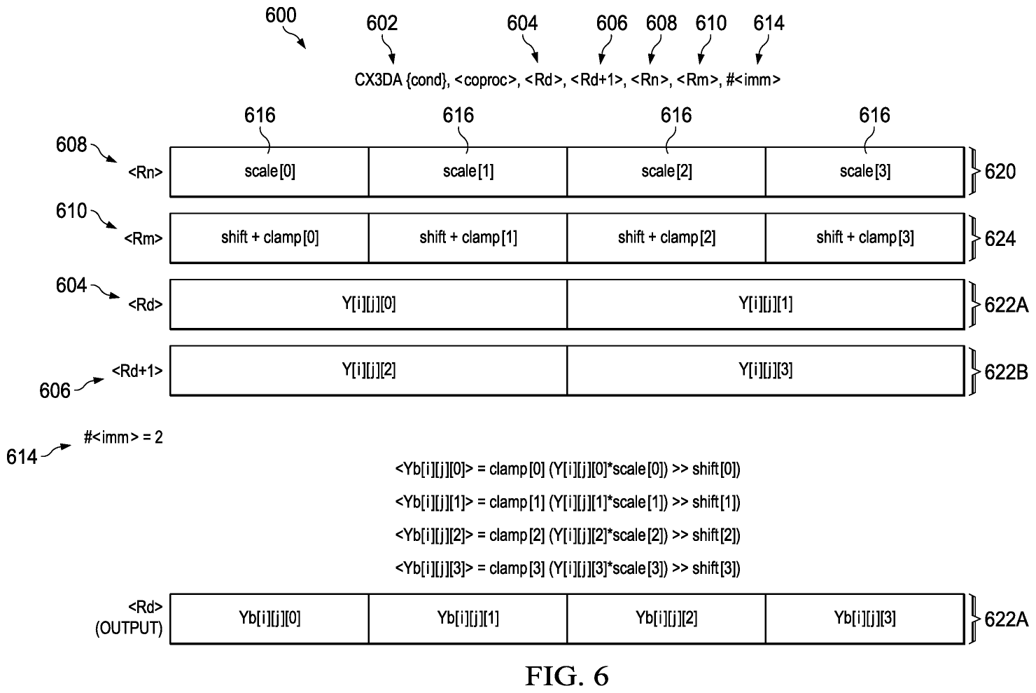

FIG. 6 is a conceptual diagram 600 of an example matrix multiplication post processing instruction for performing a matrix multiplication operation on a general purpose CPU, in accordance with aspects of this description. In diagram 600, a matrix multiplication post processing instruction CX3DA 602 is shown. Notably instruction CX3DA 602 differs from instruction CX3DA 402 in that #<imm> 614 is equal to 2, indicating that a matrix multiplication post processing operation is to be performed. The names of the various instructions described herein are examples and, in some cases, the instruction for the matrix multiplication post processing operation may have a different name as compared to the instruction for the matrix multiplication operation.

The instruction CX3DA 602 accepts four parameters, <Rd> 604, <Rd+1> 606, <Rn> 608, and <Rm> 610 for the post processing. The parameters <Rd> 604 and <Rd+1> 606 may indicate registers which are storing the output of the matrix multiplication operation. In some cases, the output values of the matrix multiplication operation may be summed with the bias in a separate instruction that may be executed before CX3DA 602. In this example, Yᵢₙ values in registers 622A and 622B indicated by parameters <Rd> 604 and <Rd+1> 606 include the bias values already summed in. Parameter <Rn> 608 may indicate a register 620 into which four scale values 616 have been written to, and parameter <Rm> 410 may indicate a register 624 into which the shift value and clamp value have been written to. In CX3DA 602, parameter #<imm> 614 is set to 2, indicating that the matrix multiplication post processing operation should be performed. Output values Yₒᵤₜ of the multiply and shift may be written into register 622A, which is indicated by parameter <Rd> 604. In some cases, additional parameters may be provided for controlling the execution of the instruction, such as {cond}, <coproc>, as described above.

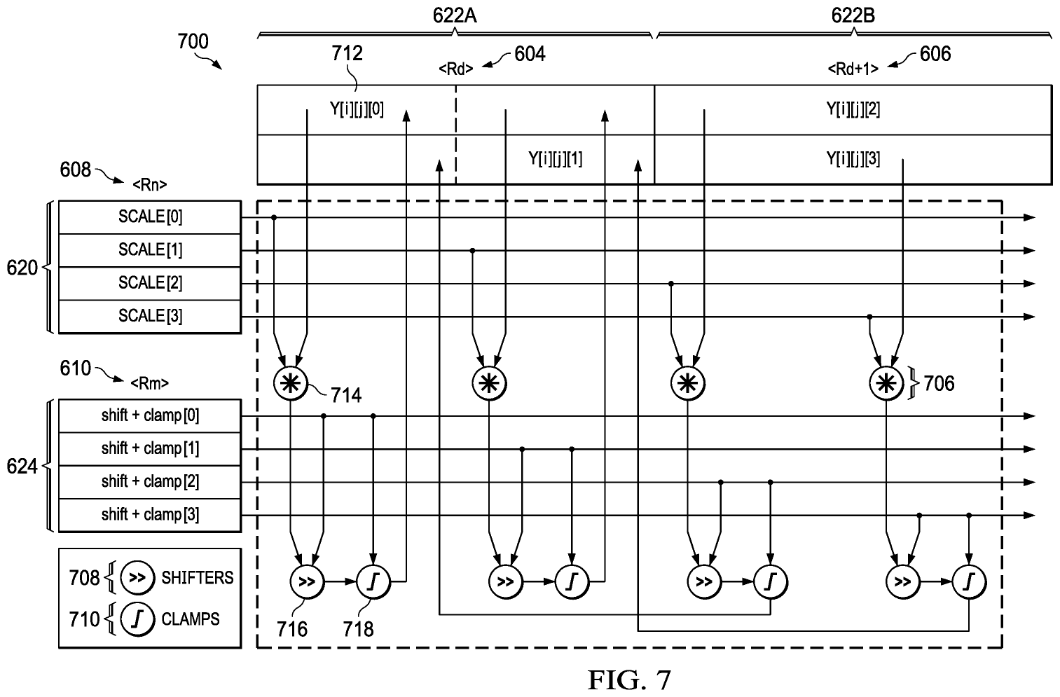

FIG. 7 is a block diagram 700 of a logical implementation for the example matrix multiplication post processing instruction, in accordance with aspects of this description. The logical implementation shown in diagram 700 illustrates an implementation of post processing instruction CX3DA 602. As shown, the logical implementation of the example matrix multiplication post processing instruction includes a set of multipliers 706 coupled to shifters 708 and clamps 710 configured to perform the post processing operation. The multipliers, shifters, and clamps may be one or more logic gates arranged to perform a multiplication operation, bit shift operation, and clamping operation, respectively. Registers 622A and 622B, corresponding to parameters <Rd> 604 and <Rd+1> 606, respectively, store the Yᵢₙ values and these registers may be coupled to the set of multipliers 706. Register 620, corresponding to parameter <Rn> 608 may store scaling factor values and may also be coupled to the set of multipliers 706. Register 624, corresponding to the parameter <Rm> 610 may store shift and clamp values and may be coupled to the shifters 708 and clamps 710.

Referring to parameter #<imm> 614 of FIG. 6, one operation to be performed can be expressed as <Yb[i][j][0]>=clamp[0] (Y[i][j][0]*scale[0])>>shift[0]). As shown, Yᵢₙ value Y[i][j][0] 712 is stored in register 622A and this value may be provided to multiplier 714 along with scale[0] stored in register 620. The output of this multiplication may be provided to shifter 716 along with a shift value stored in register 624. The shifter 716 performs a bit shift operation and the output of the bit shift operation may be provided to clamp 718 along with a clamp value stored in register 624. The clamp value may indicate a maximum and minimum value for the output of the bit shift operation and the clamps 718 may adjust the output of the bit shift operation to stay within the indicated maximum and minimum values. The output of the clamps 718 may be output back into register 604. This process may be repeated for the other Yᵢₙ values stored in registers 622A and 622B in parallel.

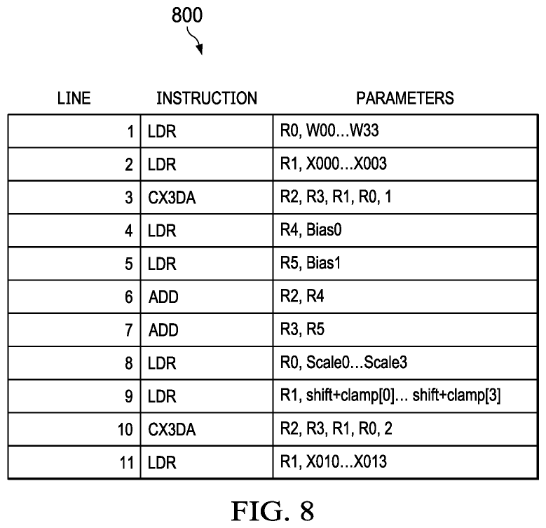

FIG. 8 illustrates example pseudocode 800 for using the added instructions for convolution, in accordance with aspects of this description. The example pseudocode 800, illustrates a convolution operation including matrix multiplication and post processing performed on an input feature map having a width of 16 (e.g., row size) features. Notably, the parameters shown for each instruction line in pseudocode 800 includes parameters relevant for the convolution operation and omits other parameters, such as control parameters, that may also be provided for the instructions. As shown, in line 1, an LDR command may be used to load a group of weights into register R0. At line 2, register R1 is loaded with a first group of four input features. At line 3, the CX3DA instruction is then called with registers R2 and R3 designated for output features. A matrix multiplication is performed based on the input features in R1 and set of weights in R0. At lines 4 and 5, registers R4 and R5 are loaded with bias values and at lines 6 and 7, the bias values are added to the output of the matrix multiplication. At line 8, register R1 is loaded with the scale values. At line 9, register R1 is loaded with shift and clamp values, and at line 10 the shift and clamp operations are performed. At line 11, R1 is loaded with a second group of four input features for the next a matrix multiplication between the second group of four input features in R1 and a group of weights. This process repeats unit all groups of input features are processed.

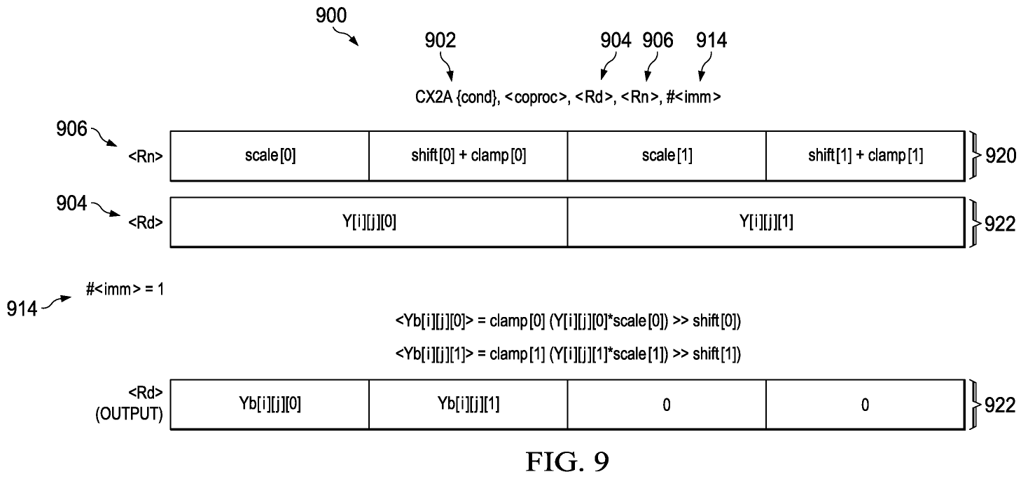

In some cases, variations of the post processing instructions may be implemented for example, to reduce a number of registers used for the instruction, alter the type of prost processing to be performed, etc. FIG. 9 is a conceptual diagram 900 of an example matrix multiplication post processing instruction for performing a matrix multiplication operation on a general purpose CPU, in accordance with aspects of this description. In diagram 900, a matrix multiplication post processing instruction CX2A 902 is shown. The post processing instruction CX2A 902 is similar to post processing instruction CX3DA 602, but is configured to take two input parameters corresponding to two registers, rather than three parameters/registers. These input parameters include parameter <Rd> 904 and parameter <Rn> 906. As shown, parameter <Rn> may indicate a register, such as register 922, which includes Yᵢₙ values. As the post processing instruction is implemented with fewer registers in this example, a number of Yᵢₙ values processed by the instruction may be reduced, as compared to other implementation of the post processing instruction. In this example, the post processing instruction CX2A 902 accepts two 16-bit Yᵢₙ values in a single 32-bit register 922 as compared to four Yᵢₙ values for post processing instruction CX3DA 602. As a number of Yᵢₙ values have been reduced, a number of scale values, shift values, and clamp values can also be reduced. As before the scale values may be an 8-bit multiplicative value, the shift may be represented by a 5-bit value, and the clamp value may be a 3-bit value with a mapping to certain predetermined ranges. Two scale values, two shift values, and two clamp values may be used for two Yᵢₙ values. The two scale values, two shift values, and two clamp values may be stored in a single 32-bit register 920. In post processing instruction CX2D 902, parameter #<imm> 914 may be set to 1, indicating that the matrix multiplication post processing operation should be performed. The matrix multiplication post processing operation is substantially similar to that described with respect to FIG. 6 and FIG. 7 as applied to the two Yᵢₙ values. Output values Yₒᵤₜ of the multiply and shift may be written into register 922, which is indicated by parameter <Rd> 904. In this example, as Yₒᵤₜ values are 8-bit and two Yₒᵤₜ values are produced by two Yᵢₙ values, the two output Yₒᵤₜ values may occupy half of the bits of register 922. Null values, such as 0 may be used to fill the remaining bits of the register.

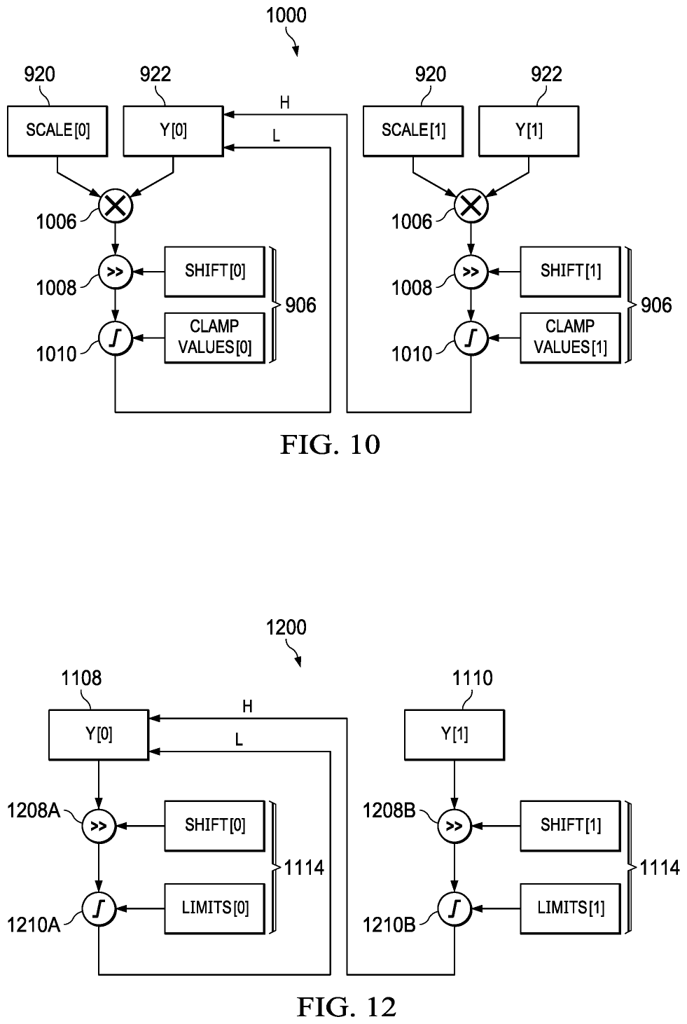

FIG. 10 is a block diagram 1000 of a logical implementation of a matrix multiplication post processing instruction, in accordance with aspects of this description. The logical implementation shown in diagram 1000 illustrates an implementation of post processing instruction CX2A 902. As shown, the logical implementation of the example matrix multiplication post processing instruction includes a set of multipliers 1006 coupled to a set of shifters 1008 and a set of clamps 1010 configured to perform the post processing operation. Register 922, corresponding to parameter <Rd> stores the Yᵢₙ values and register 922 may be coupled to the set of multipliers 1006. Register 920, corresponding to parameter <Rn> 906 may store scaling factor values, shift values, and clamp values and may also be coupled to the set of multipliers 1006. The output of the clamps 1010 may be output back into register 922. This logical implementation is substantially similar to the logical implementation described in FIG. 7 with fewer operations execution in parallel.

Referring to parameter #<imm> 914 of FIG. 6, one operation to be performed can be expressed as <Yb[i][j][0]>=clamp[0] (Y[i][j][0]*scale[0])>>shift[0]). This operation is performed in a way substantially similar to that described above in conjunction with FIG. 7.

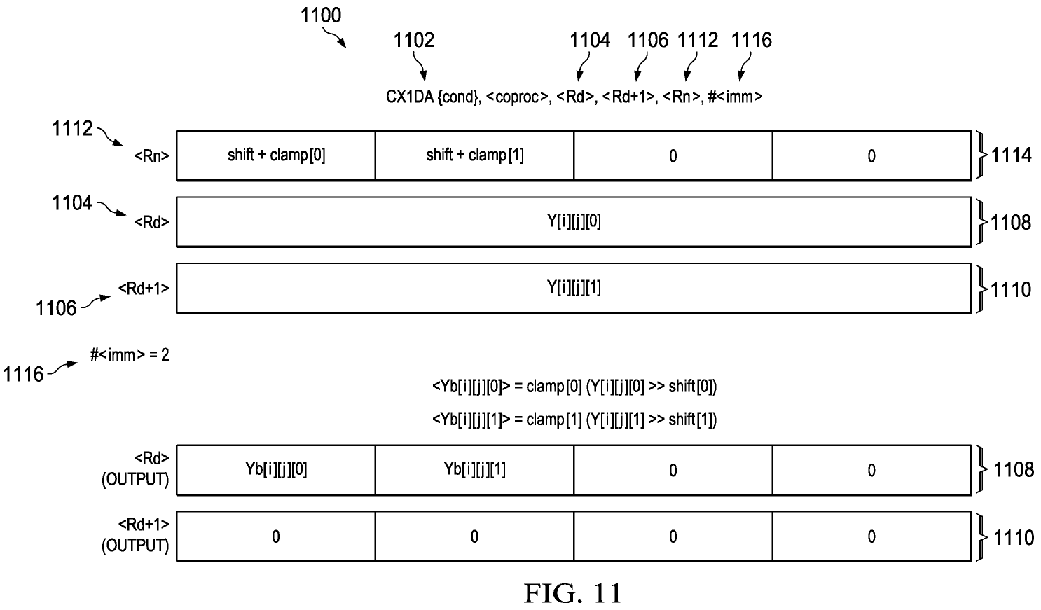

FIG. 11 is a conceptual diagram 1100 of an example matrix multiplication post processing instruction for performing a matrix multiplication operation on a general purpose CPU, in accordance with aspects of this description. In diagram 1100, a matrix multiplication post processing instruction CX2DA 1102 is shown. Post processing instruction CX2DA illustrates an alternative example of a matrix multiplication post processing instruction which accepts as input three input parameters corresponding to three registers. In this example, the Yᵢₙ values are 32-bit values and the post processing operation performs a shift and clamp operation, but does not include a scaling operation.

Post processing instruction CX2DA 1102 may operate on two Yᵢₙ values in parallel. Two Yᵢₙ values may be provided to instruction CX2DA 1102 via parameters <Rd> 1104 and <Rd+1> 1106. Parameter <Rd> 1104 may include an indication to register 1108 and parameter <Rd+1> 1106 may include an indication to register 1110. Registers 1108 and 1110 may store the two Yᵢₙ values. Parameter <Rn> 1112 may include an indication to register 1114 and register 1114 may store a shift value and clamp value to apply to the Yᵢₙ values. The shift may be represented by a 5-bit value and the clamp value may be a 3-bit value with a mapping to certain predetermined ranges, such as 0-255, 0-127 , −128-127, etc. Two shift values and two clamp values may be stored in half of register 1114. In post processing instruction CX2DA 1102, parameter #<imm> 1116 may be set to 1, indicating that the matrix multiplication post processing operation should be performed. The matrix multiplication post processing operation CX2DA 1102 performs a right shift on the Yᵢₙ values and clamps the resulting shifted values. The post processing operation may be expressed as Yₒᵤₜ=clamp((Yᵢₙ+Bias)>> Shift, Low, High). In some cases, the Yᵢₙ values may include the bias. In this example, as Yₒᵤₜ values are 8-bit and two Yₒᵤₜ values are produced by two Yᵢₙ values, the two output Yₒᵤₜ values may occupy half of the bits of register 1108. Null values, such as 0 may be used to fill the remaining bits of the register. In some cases, register 1110 may also be filled with null values on output.

FIG. 12 is a block diagram 1200 of a logical implementation for the example matrix multiplication post processing instruction, in accordance with aspects of this description. The logical implementation shown in diagram 1200 illustrates an implementation of post processing instruction CX2DA 1102. As shown, the logical implementation of the example matrix multiplication post processing instruction includes a set of shifters 1208A-1208B coupled to a set of clamps 1210A-1210B configured to perform the post processing operation. Register 1108, corresponding to parameter <Rd> stores a Yᵢₙ[0] value and register 1108 may be coupled to shifter 1208A. The Yᵢₙ[0] value may be provided to shifter 1208A. Shifter 1208A may receive a shift value from register 1114 and perform a right shift on the Yᵢₙ[0] value. The result of the right shift may be provided to clamp 1210A. Clamp 1210A may receive a clamp value from register 1114 and clamp the results of the right shift. A result of the clamping may then be output into register 1108.

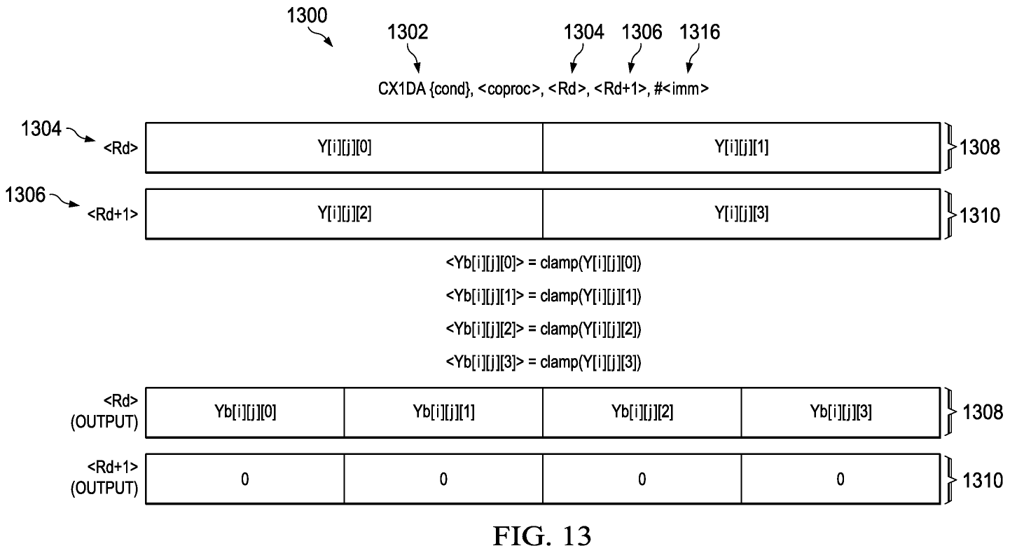

FIG. 13 is a conceptual diagram 1300 of an example matrix multiplication post processing instruction for performing a matrix multiplication operation on a general purpose CPU, in accordance with aspects of this description. In diagram 1300, a matrix multiplication post processing instruction CX1DA 1302 is shown. Post processing instruction CX1DA illustrates an alternative example of a matrix multiplication post processing instruction which accepts as input two input parameters corresponding to two registers. In this example, the Yᵢₙ values are 16-bit values four Yᵢₙ values may be input via parameters <Rd> 1304 and <Rd+1> 1306. Parameter <Rd> 1304 may include an indication to register 1308, which stores Yᵢₙ [0] and Yᵢₙ [1], and parameter <Rd+1> 1306 may include an indication to register 1310, which stores Yᵢₙ [2] and Yᵢₙ [3]. Post processing instruction CX1DA 1302 performs a clamp operation on four Yᵢₙ values in parallel and outputs four 8-bit Yₒᵤₜ values in register 1308. In some cases, register 1310 may be filled with null values on output. In post processing instruction CX1DA 1302, parameter #<imm> 1316 may be use to indicate a clamp range. For example, if #<imm> 1316 is equal to 0, clamp-low=0 and clamp-high=255. If <#imm> 1316 is equal to 1, clamp-low=−128, clamp-high=127. If <#imm> 1316 is equal to 2, clamp-low=0; clamp-high=127, etc. The post processing operation may be expressed as Yₒᵤₜ=clamp((Yᵢₙ+Bias), Low, High). In some cases, the Yᵢₙ values may include the bias.

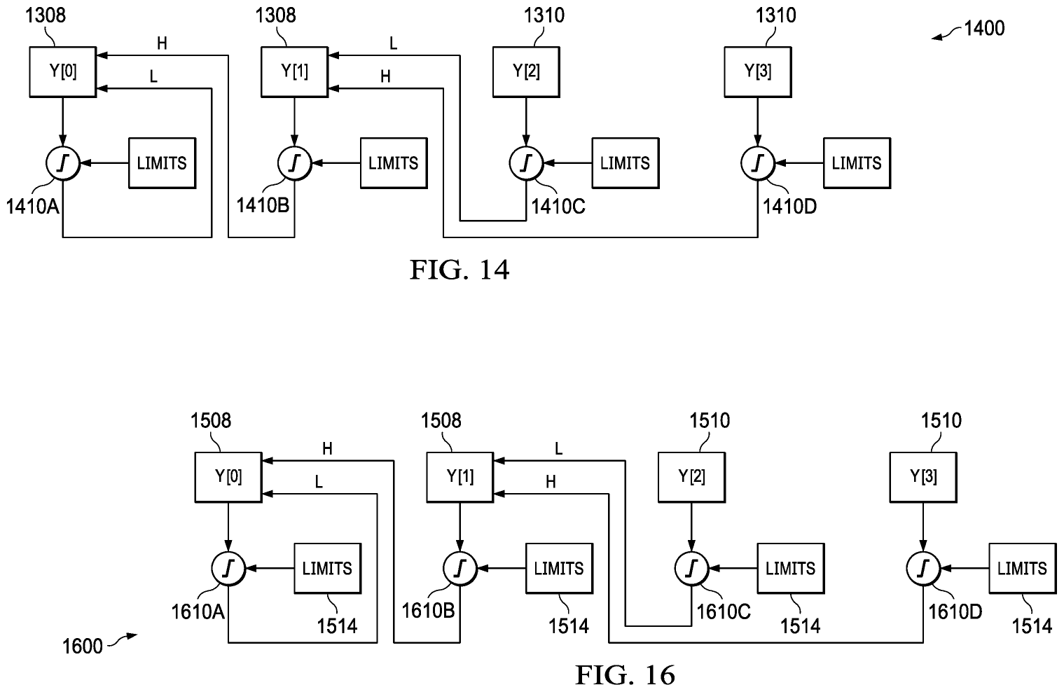

FIG. 14 is a block diagram 1400 of a logical implementation for the example matrix multiplication post processing instruction, in accordance with aspects of this description. The logical implementation shown in diagram 1400 illustrates an implementation of post processing instruction CX1DA 1302. As shown, the logical implementation of the example matrix multiplication post processing instruction includes a set of clamps 1410A-1410D configured to perform the post processing operation. Register 1308 may be coupled to clamps 1410A and 1410B and register 1310 may be coupled to clamps 1410C and 1410D. Clamps 1410 may infer clamp values based on a value of parameter #<imm> 1316. Clamps 1410 may receive Yᵢₙ values from registers 1308 and 1310 and clamp the Yᵢₙ values. Output from clamps 1410 may be provided to register 1308.

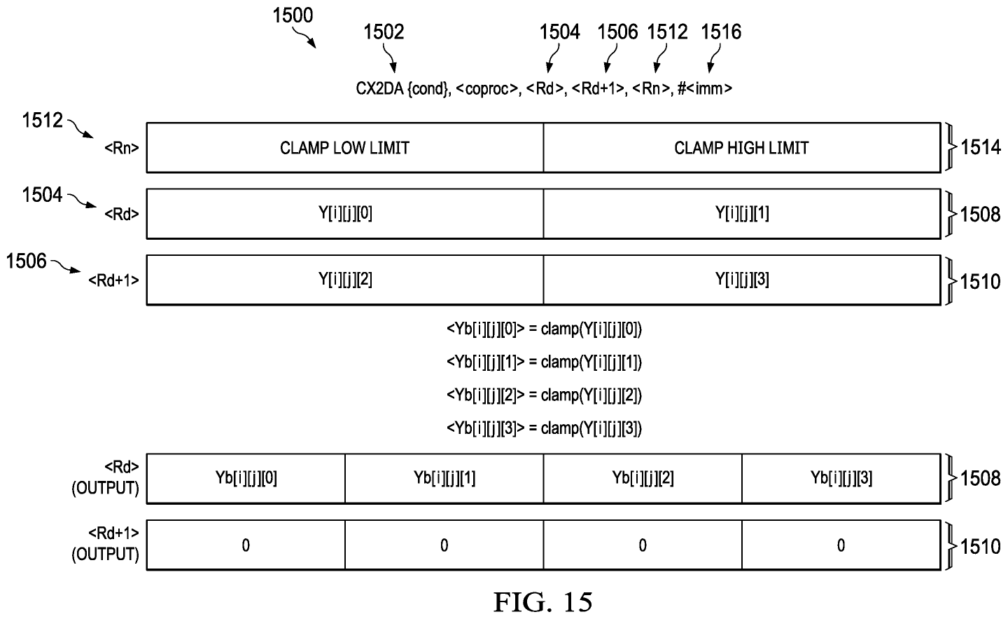

FIG. 15 is a conceptual diagram 1500 of an example matrix multiplication post processing instruction for performing a matrix multiplication operation on a general purpose CPU, in accordance with aspects of this description. In diagram 1500, a matrix multiplication post processing instruction CX2DA 1502 is shown. In some cases, CX2DA may be implemented along with CX2DA 1102 and distinguished, for example, based on the #imm value 1516. Post processing instruction CX2DA 1502 illustrates an alternative example of a matrix multiplication post processing instruction which accepts as input three input parameters corresponding to three registers. Post processing instruction CX2DA 1502 differs from post processing instruction CX2DA 1102 as post processing instruction CX2DA 1502 performs a clamp operation based on specified high and low values, but does not include a shift operation and operates on 16-bit Yᵢₙ values. Post processing instruction CX2DA 1502 may operate on four Yᵢₙ values in parallel. Four Yᵢₙ values may be provided to instruction CX2DA 1502 via parameters <Rd> 1504 and <Rd+1> 1506. Parameter <Rd> 1504 may include an indication to register 1508 and parameter <Rd+1> 1506 may include an indication to register 1510. Registers 1508 and 1510 may store the four Yᵢₙ values. Post processing instruction CX2DA 1502 also takes a third parameter, parameter <Rd> 1512, which includes an indication to register 1514. Register 1514 may store a high and low clamp value. The clamp values may be specified and may be set to any supported value. In this case, the clamp values are 16-bit and may be set to any 16-bit value. The matrix multiplication post processing operation CX2DA 1502 performs a clamping operation on the Yᵢₙ values in parallel and outputs four Yₒᵤₜ values. The Yₒᵤₜ values may be provided to register 1508. In some cases, register 1510 may be filled with null values on output.

FIG. 16 is a block diagram 1600 of a logical implementation for the example matrix multiplication post processing instruction, in accordance with aspects of this description. The logical implementation shown in diagram 1600 illustrates an implementation of post processing instruction CX2DA 1502. As shown, the logical implementation of the example matrix multiplication post processing instruction includes a set of clamps 1610A-1610D configured to perform the post processing operation. Register 1508 may be coupled to clamps 1610A and 1610B and register 1510 may be coupled to clamps 1610C and 1610D. Clamp values may be input from register 1514. Clamps 1610 may receive Yᵢₙ values from registers 1508 and 1510 and clamp the Yᵢₙ values. Output from clamps 1610 may be provided to register 1508.

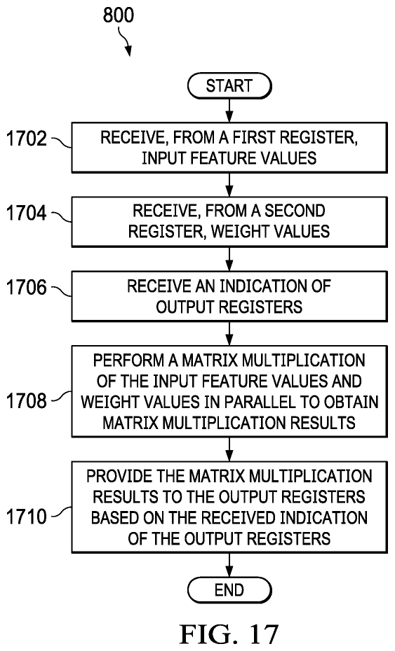

FIG. 17 is flow diagram of a technique 1700 for matrix multiplication by a processor, in accordance with aspects of this description. At block 1702, a plurality of input feature values are received. For example, a processor instruction may take a group of input feature values as a variable and this group of input feature values may be stored in a register. The processor instruction passes an address of this register to the processor. At block 1704, weight values are received from a second register. For example, the processor instruction may also take a set of weights and the set of weights may be stored in another register. The weights may have values in a binary or trinary format such as [1, 0, and −1] or [1, −1]. At block 1706, an indication of output registers is received. For example, the processor instruction may also take an address corresponding to a set of output registers for providing results to. At block 1708, a matrix multiplication of the input feature values and weight values is performed in parallel to obtain matrix multiplication results. For example, input the features values and the weights may be processed, by a set of multipliers of a processor, to obtain intermediate results. Input feature values may be multiplied by weights by multipliers of the processor. Where the weights are in a binary or trinary format, the multipliers may be configured to implemented as conditional add/zero/subtract operations. In some cases, the intermediate results are processed, by a series of adders of the processor to obtain an output value. For example, the adders help sum up the intermediate results to the output value. At block 1710, the matrix multiplication results are provided to the set of output registers based on the received indication.

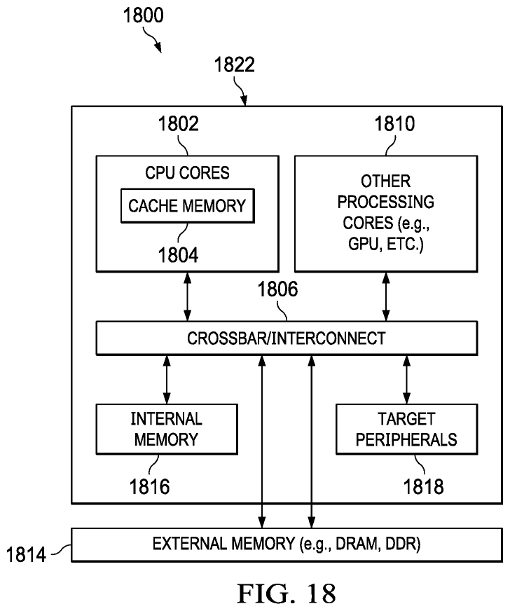

FIG. 18 is a block diagram of a device 1800 in accordance with aspects of this description. The device may be system on a chip (SoC) 1822, including multiple components configured to perform different tasks. As shown, the device includes one or more central processing unit (CPU) cores 1802, which may include one or more internal cache memories 1804. The CPU cores 1802 may be configured for general computing tasks.

The CPU cores 1802 may be coupled to a crossbar (e.g., interconnect) 1806, which interconnects and routes data between various components of the device. In some cases, the crossbar 1806 may be a memory controller or any other circuit that can provide an interconnect between peripherals. Peripherals may include host peripherals (e.g., components that access memory, such as various processors, processor packages, direct memory access (DMA)/input output components, etc.) and target peripherals 1818 (e.g., memory components, such as double data rate (DDR) random access memory, other types of random access memory, DMA/input output components, etc.). In some cases, the processing cores, such as CPU cores 1802, other processing cores 1810 and crossbar 1806 may be integrated on a single chip, such as SoC 1822 with a separate external memory. In this example, the crossbar 1806 couples the CPU cores 1802 with other peripherals, such as the other processing cores 1810, such as a graphics processing unit, radio basebands, coprocessors, microcontrollers, etc., and external memory 1814, such as DDR memory, dynamic random access memory (DRAM), flash memory, etc., which may be on a separate chip from the SoC 1822. The crossbar 1806 may include or provide access to one or more internal memories 1816 that may include any type of memory, such as static random-access memory (SRAM), flash memory, read-only memory (ROM), etc.

In some cases, the device may be an embedded device which is built into another device and may perform a specific function for the other device. Often embedded devices are resource constrained with a relatively limited amount of compute and memory resources.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Modifications are possible in the described embodiments, and other embodiments are possible, within the scope of the claims.

What is claimed is:

1. A method for controlling a processing device, the method comprising:
receiving, from a first register, input feature values;
receiving, from a second register, weight values;
receiving an indication of output registers;
performing a matrix multiplication of the input feature values and weight values in parallel to obtain matrix multiplication results; and
providing the matrix multiplication results to the output registers based on the received indication of the output registers.

2. The method of claim 1, further comprising:
receiving an indication toto perform a post processing operation on the output matrix multiplication results;
generating a post processed result by clamping the matrix multiplication results to limit the matrix multiplication results to a range; and
providing the post processed result in the output registers.

3. The method of claim 2, further comprising performing a bit shift operation.

4. The method of claim 3, further comprising:
receiving an indication of a clamp range and a shift value; wherein:
the clamping is based on the indication of the clamp range, and
the bit shift operation is performed based on the shift value.

5. The method of claim 4, further comprising receiving scaling values.

6. The method of claim 5, wherein the post processing operation includes multiplying the matrix multiplication results with the scaling values.

7. The method of claim 2, further comprising receiving an indication of a clamp range, wherein the clamping operation is performed based on the indication of the clamp range.

8. The method of claim 2, wherein a bias is applied to the output matrix multiplication results before the post processing operation.

9. The method of claim 1, wherein values of the weights include one of binary values or ternary values.

10. A system, comprising:
a first register configured to receive input feature values;
a second register configured to receive weights;
output registers;
a processor including:
a set of multipliers, and
a series of adders, wherein the processor is configured to:
receive the input feature values from the first register;
receive the weights from the second register;
receive an indication of the output registers;
process, by the set of multipliers, the input feature values and the weights to obtain intermediate results;
process, by the series of adders, the intermediate results to obtain a matrix multiplication output value; and
output the matrix multiplication output value to the output registers based on the received indication.

11. The system of claim 10, wherein values of the weights include one of binary values or ternary values.

12. The system of claim 10, wherein the processor is configured to perform a post processing operation on the matrix multiplication output value, wherein the post processing operation includes:
generate a post processed result by clamping the matrix multiplication output value to limit the matrix multiplication output value to a range; and
providing the post processed result to the output registers.

13. The system of claim 12, wherein the processor is configured to perform a bit shift operation.

14. The system of claim 13, wherein the processor is configured to:
receive an indication of a clamp range and a shift value, wherein the clamping is performed based on the indication of the clamp range, and the bit shift operation is performed based on the shift value.

15. The system of claim 14, wherein the processor is configured to:
receive a set of scaling values; and
multiply the matrix multiplication output value with scaling values of the set of scaling values.

16. The system of claim 12, wherein the processor is configured to receive an indication of a clamp range and the clamping is performed based on the indication of the clamp range.

17. The system of claim 10, wherein a bias is applied to the matrix multiplication output valuer before the post processing operation.

18. An electronic circuit comprising:
a first register configured to store input feature values;
a second register configured to store weight values;
output registers configured to provide a matrix multiplication output value; and
a processor coupled to the first register, the second register, and the output registers, the processor comprising:
a set of multipliers configured to process the input feature values and the weights to obtain intermediate results; and
a series of adders configured to process the intermediate results to obtain the output value.

19. The electronic circuit of claim 18, wherein values of the weights include one of binary values or ternary values.

20. The electronic circuit of claim 18, wherein the processor further comprises a clamping circuit configured to perform a clamping operation on the matrix multiplication output value limiting the matrix multiplication results to a range to generate a post processed result, and the output registers are configured to provide the post processed result.
